(19) United States
(12) Patent Application Publication
(10) Pub. No.: US 2007/0055895 A1
(43) Pub. Date: Mar. 8, 2007

(54) IMAGE PROCESSING DEVICE, RECORDING MEDIUM, AND PROGRAM

(75) Inventor: Masaya OKUDA, Osaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KYOCERA MITA CORPORATION, Osaka-shi (JP)

(21) Appl. No.: 11/466,547

(22) Filed: Aug. 23, 2006

(30) Foreign Application Priority Data
Sep. 5, 2005 (JP) 2005-257121

(51) Int. Cl. G06F 12/14; H04L 9/32; G06F 11/30

(52) U.S. Cl. 713/193

(57) ABSTRACT

The present invention relates to an information processing device equipped with an encrypting/decrypting unit which encrypts or decrypts data as well as an encryption/decryption enabling/disabling switching unit, which enables the encrypting/decrypting unit to encrypt the file data upon recording such file data in a recording medium, and disables the encrypting/decrypting unit to prevent the deleting data used to overwrite and erase file data from being encrypted when such file data recorded in the recording medium is overwritten and deleted.

### BACKGROUND OF THE INVENTION

1. Field of the Invention

The present invention relates to an information processing device such as a personal computer and a printer capable of recording information in a hard disk or other recording medium, and more particularly, to an information processing device and a program therefor equipped with a function for recording data in a recording medium by using encryption processing means, and for preventing the encryption algorithm from being deciphered when recorded data is overwritten and deleted by a constant number.

2. Description of the Related Art

It is common practice to install a recording medium such as a hard disk on personal computers and copying machines and printers set up in offices. Such a hard disk installation is removable, and if the hard disk is removed at the time the machine is disposed of, there is a risk of leaking sensitive data should the machine come into the possession of a third party. Conventionally, this problem is addressed by destroying the hard disk when the machine is discarded, or by encrypting the data upon recording in the hard disk.

For example, in Japanese Laid-Open Patent Publication No. 2004-282717, an example of a device provided with means to encrypt data written in a hard disk has been disclosed, whereby the level of security in an image processing device is increased by changing the operations to be applied to image data, such that external image data inputted is encrypted, the encrypted image data then being stored in an image data storing means, and the encrypted data stored in the image data storing means is thereafter decrypted to supply an image processing means with the decrypted image data. Thus, by means of this image processing device, it is possible to prevent the data from being read by unauthorized users even if the hard disk is physically removed from the device, since file data stored in the hard disk has been encrypted.

However, in the image processing device disclosed in the above invention, a problem may arise when the data stored in the image data storing means is deleted. In particular, when Null characters are used to overwrite for the purpose of deleting, the Null characters themselves are encrypted by an encrypting/decrypting means, such that the characters overwritten in the relevant data file in the hard disk are not the original Null characters, but the encrypted Null characters.

Consequently, when an array of simple strings such as the Null characters is encrypted, it is possible to determine the encryption key roughly by analyzing the overwriting characters as well as to decipher the algorithm used by the encrypting/decrypting means rather easily. Once the algorithm is deciphered, the data in the image processing device naturally cannot be secured.

### SUMMARY OF THE INVENTION

The present invention has been designed to secure file data recorded in a recording medium, and more particularly, to prevent the encryption and decryption algorithms from being deciphered.

The present invention also aims to prevent an encryption and decryption algorithm from being deciphered when file data recorded in a recording medium is deleted by overwriting with a constant number such as a Null character, by preventing the Null character itself from being encrypted.

The present invention further aims to enable information processing devices to handle multiple tasks by switching encrypting/decrypting means when a recording or overwriting and deleting process is being executed with respect to certain file data in a recording medium, and is interrupted by another process of recording or overwriting and deleting other file data.

To attain the above objectives, an information processing device is provided in accordance with the first aspect of the present invention, which includes an encrypting means for encrypting file data and stores the encrypted file data in a data recording medium, a data recording means for recording the encrypted file data in the data recording medium, a deleting means for generating deleting data in order to delete the file data recorded by the data recording means, and an encryption enabling/disabling switching means for enabling the encryption of file data by the encrypting means if ordinary data is recorded in the data recording medium and disabling the encryption carried out by the encrypting means for the deleting data generated by the deleting means if file data recorded in the data recording medium is erased by overwriting the file data with deleting data.

According to the second aspect of the present invention, an information processing device is provided in accordance with the first aspect of the invention where the process of recording or deleting first file data is suspended if there is an interruption requiring the recording or deletion of second file data and such recording or deletion takes place.

According to the third aspect of the present invention, an information processing device is provided in accordance with the first aspect of the invention where the device includes a set value storing means for storing the state of the encryption enabling/disabling switching means as a set value, and the encryption enabling/disabling switching means enables or disables data encryption using the encrypting means based on the set value stored in the set value storing means.

According to the fourth aspect of the present invention, an information processing device is provided in accordance with the third aspect of the invention where, during the process of recording or deleting first file data, the encryption enabling/disabling switching means enables or disables the encryption of first file data by the encrypting means based on the first set value stored in the set value storing means to execute recording or deletion, and, if there is an interruption requiring the recording or deletion of second file data, the recording or deletion of first file data is suspended, and the encryption enabling/disabling switching means enables or disables the encryption of the second file data by the encrypting means based on the second set value stored in the set value storing means to execute recording or deletion, and upon completion of the recording or deletion of the second file data, the encryption enabling/disabling switching means again enables or disables the encryption of first file data by the encrypting means based on the first set value to resume the process of recording or deletion of first file data.

According to the fifth aspect of the present invention, an information processing device is provided in accordance with the first aspect of the invention, where the deleting data generated by the deleting means in order to erase file data recorded by the data recording means comprises constant number data.

According to the sixth aspect of the present invention, a computer-readable recording medium is provided which records a program for causing a computer connected to or provided with the data recording medium to realize an encrypting function for encrypting file data, a data recording function for recording the encrypted file data in the data recording medium, a deleting function for generating deleting data in order to delete the file data recorded by the data recording function, and an encryption enabling/disabling switching function for enabling the encryption of file data if ordinary data is recorded in the data recording medium, and disabling the encryption of deleting data if file data recorded in the data recording medium is deleted by overwriting the file data with deleting data.

According to the seventh aspect of the present invention, a computer-readable recording medium is provided in accordance with the sixth aspect of the invention where the recording or deletion of first file data in the data recording medium is suspended if there is an interruption requiring the recording or deletion of second file data, and the recording or deletion of such second file data ensues.

According to the eighth aspect of the present invention, a computer-readable recording medium is provided in accordance with the sixth aspect of the invention where the state of the encryption enabling/disabling switching function is stored as a set value, and the encryption of file data is enabled or disabled based on the set value.

According to the ninth aspect of the present invention, a computer-readable recording medium is provided in accordance with the eighth aspect of the invention where, during the process of recording or deleting first file data in the data recording medium, the encryption of first file data is enabled or disabled based on the stored first set value to execute recording or deletion and if there is an interruption requiring the recording or deletion of second file data, the recording or deletion of first file data is suspended, and the encryption of second file data is enabled or disabled based on the stored second set value to execute recording or deletion, and upon completion of the recording or deletion of second file data, the encryption of first file data is again enabled or disabled based on the stored first set value to resume the recording or deletion of first file data.

According to the tenth aspect of the present invention, a computer-readable recording medium is provided in accordance with the sixth aspect of the invention where the deleting data generated by the deleting function comprises constant number data.

According to the eleventh aspect of the present invention, a data processing method is also provided for a computer connected to or provided with a data recording medium, comprising an encrypting step for encrypting file data, a data recording step for recording the encrypted file data in the data recording medium, a deleting step for generating deleting data in order to delete the file data recorded by the data recording step, and an encryption enabling/disabling switching step for enabling the encryption of file data if ordinary data is recorded in the data recording medium, and for disabling the encryption of the deleting data if file data recorded in the data recording medium is deleted by overwriting the file data with deleting data.

According to the twelfth aspect of the present invention, the data processing method provided in accordance with the eleventh aspect of the invention includes the step of suspending the recording or deletion of first file data if there is an interruption requiring the recording or deletion of second file data, and the recording or deletion of such file data takes place.

According to the thirteenth aspect of the present invention, the data processing method provided in accordance with the eleventh aspect of the invention includes the step of storing the state of the encryption enabling/disabling switching as a set value, and the step of enabling or disabling the encryption of file data based on the set value.

According to the fourteenth aspect of the present invention, the data processing method is provided in accordance with the thirteenth aspect of the invention which includes, upon recording or deletion of first file data, the step of enabling or disabling the encryption of first file data based on the stored first set value to execute the process of recording or deletion, and if there is an interruption requiring the recording or deletion of second file data, the process of recording or deleting first file data is suspended, and enabling or disabling the encryption of the second file data based on the stored second set value to execute recording or deletion, and upon completion of the recording or deletion of second file data, enabling or disabling the encryption of first file data based on the first set value to resume the recording or deletion of first file data.

According to the fifteenth aspect of the present invention, a data processing method is provided in accordance with the eleventh aspect of the invention where the deleting data generated during the generating step comprises constant number data.

According to the first aspect of the present invention, the encrypting/decrypting means is operated by enabling it when data is recorded in the recording medium, and the data recorded in the recording medium is encrypted, thereby preserving the confidentiality of such recorded data. Moreover, when data recorded in the recording medium is overwritten and deleted, the encrypting/decrypting means is deactivated and thereby disabled to prevent the overwriting and deleting data from being encrypted, thereby preventing the encryption algorithm from being deciphered.

According to the second aspect of the present invention, during the process of recording or deleting certain file data, if there is a request to process other file data, or in other words an interruption occurs, such recording or deleting is temporarily suspended, and processing of new or other file data ensues, thereby enabling the computer to process multiple tasks in the order of priority.

According to the third aspect of the present invention, since the set value storing means is made to store the state of the encryption enabling/disabling switching means as a set value, and the encryption means is switched based on the set value, shifting between enabling and disabling of encryption can be easily done if the set value is received together with file data or a processing request, for example.

According to the fourth aspect of the present invention, when an interruption occurs requiring the processing of other file data, the set value of the process under execution is temporarily saved, and the saved set value is restored at the end of the interruption, such that the previous process resumes upon restoration of the previously set value even if the interruption does not normally end.

According to the fifth aspect of the present invention, when the constant number data is used to overwrite and delete data in the recording medium, it is possible to prevent the constant number data itself from being encrypted, thereby preventing the encryption algorithm from being deciphered.

According to the sixth aspect of the present invention, a program is provided wherein, during the process of recording data in the recording medium, the encryption/decryption means is enabled and made to operate, such that the data to be recorded in the recording medium is encrypted, thereby keeping the confidentiality of the recorded data secure. Moreover, when data recorded in the recording medium is overwritten and deleted, the program provided herewith deactivates the encrypting/decrypting function to disable it and prevent such data used to overwrite and delete from being encrypted, thereby preventing the encryption algorithm from being deciphered.

According to the seventh aspect of the present invention, a program is provided wherein, during the process of recording or deleting certain data, such process is temporarily suspended when an interruption occurs requiring the processing of new file data, thereby enabling the image processing device to accomplish multi-tasking according to priority.

According to the eighth aspect of the present invention, a program is provided wherein shifting between enabling and disabling of the encryption is easily achieved by receiving the set value together with file data or a request for processing, for example, since the set value storing means is made to store the state of the encryption enabling/disabling switching means as a set value, and the encryption means is switched based on the set value.

According to the ninth aspect of the present invention, a program is provided, wherein the set value of the process currently being executed is temporarily saved when there is an interruption requiring the processing of other file data, and the saved set value is restored at the end of the interruption, thereby allowing the previous process to resume as well as accomplishing the same by restoring the previously set value, even if the interruption does not normally end.

According to the tenth aspect of the present invention, a program is provided which can prevent the constant number data used to overwrite and delete data in the recording medium from being encrypted, thereby preventing the encryption algorithm from being deciphered.

According to the eleventh aspect of the present invention, a data processing method is provided, wherein during the process of recording data in the recording medium, the encrypting/decrypting means is activated and made to operate such that the data to be recorded in the recording medium is encrypted, thereby preserving the confidentiality of the recorded data. Moreover, when data recorded in the recording medium is overwritten and deleted, the data processing method provided herewith causes the encrypting/decrypting function to deactivate and thereby disable it to prevent the data used to overwrite and delete from being encrypted, thereby preventing the encryption algorithm from being deciphered.

According to the twelfth aspect of the present invention, a data processing method is provided by which the recording or deletion of certain data is temporarily suspended if there is an interruption requiring the processing of other file data, and such new file data is processed, thereby enabling the image processing device to accomplish multi-tasking according to priority.

According to the thirteenth aspect of the present invention, since the set value storing means is made to store the state of the encryption enabling/disabling switching means as a set value, and the encryption means is switched based on the set value, a data processing method can be provided by which shifting between enabling and disabling of encryption can be easily achieved if the set value is received together with file data or a processing request, for example.

According to the fourteenth aspect of the present invention, a data processing method is provided by which the set value of the process currently being executed is temporarily saved when there is an interruption requiring the processing of other file data, and the saved set value is restored at the end of the interruption, thereby allowing the previous process to resume as well as accomplishing the same by restoring the previously set value, even if the interruption does not normally terminate.

According to the fifteenth aspect of the present invention, a data processing method is provided by which the constant number data used to overwrite and delete can be prevented from being encrypted when constant number data is used to delete data in the recording medium, thereby preventing the encryption algorithm from being deciphered.

### BRIEF DESCRIPTION OF THE DRAWINGS

FIG. 1 is a diagram showing an overview and function blocks of an image forming device according to the first embodiment of the present invention;

FIG. 2 is the flow chart of image processing by the image forming device according to the first embodiment of the present invention;

FIG. 3 is a diagram showing an overview and function blocks of an image forming device according to the second embodiment of the present invention;

FIG. 4 is a flow chart of image processing by the image forming device according to the second embodiment of the present invention; and

FIG. 5 is a time chart showing the operation and transition of a set value when an interruption occurs in the image processing device according to the second embodiment of the present invention.

### DETAILED DESCRIPTION OF THE PREFERRED EMBODIMENTS

A detailed description will now be given of the embodiments of the present invention with reference to the drawings.

### First Embodiment

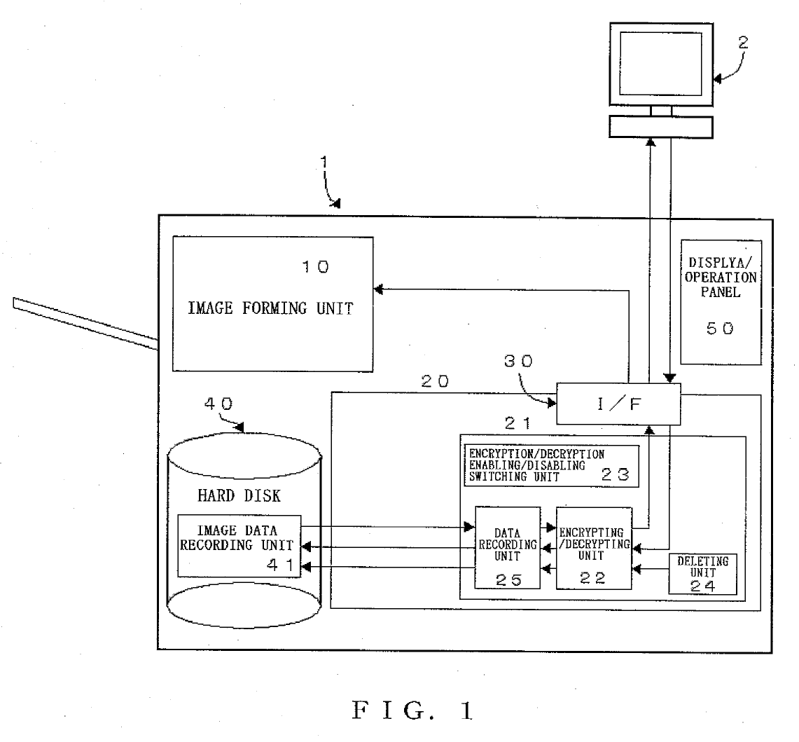

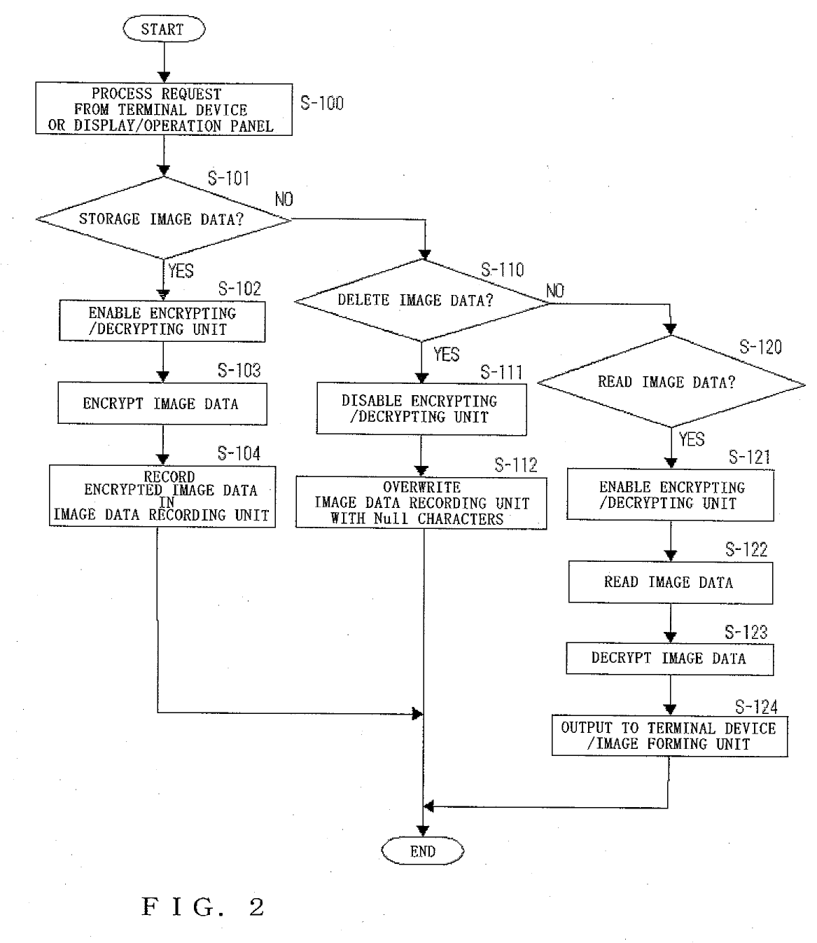

The information processing device according to the first embodiment of the present invention will be described hereafter with reference to FIGS. 1 and 2. FIG. 1 is an overview and a function block diagram of an example of an information processing device which shifts between enabling and disabling of an encrypting/decrypting unit, while FIG. 2 is a flowchart showing the data recording/deleting processes executed by the information processing device.

With reference to FIG. 1, the image processing device according to the first embodiment of the invention refers to an image forming device 1 such as a printer, a copying machine, and a facsimile. The image forming device 1 includes an image forming unit 10, an image processing unit 20, an interface unit 30, a hard disk 40, and a display/operation panel 50. Moreover, the image forming device 1 is connected to a terminal device 2 such as a computer via a network connection or such other connection method for transmitting/receiving image data. The image forming unit 10 includes a printing unit which forms an image from image data received from the terminal device 2, as well as image data which is read from the hard disk 40, and is processed by the image processing unit 20, which will be described in more detail. The printing unit includes a laser scanner unit, and an ink jet printer device.

The image processing unit 20 includes a control unit 21, which in turn actually includes a CPU, and carries out data processing by reading out a program stored in a memory or the like, which is not shown, and executing the program while using such memory, which is not shown, as a work area. The control unit 21 primarily includes an encrypting/decrypting unit 22, an encryption/decryption enabling/disabling switching unit 23, a deleting unit 24, and a data recording unit 25.

The encrypting/decrypting unit 22 performs the function of encrypting image data received from the terminal device 2, and of decrypting image data read out from the hard disk 40. The encryption and decryption of image data is realized by providing data used as an “encryption key”, and carrying out the exclusive operation between the encryption key and data once stored in the memory. Other methods may be used, such as the permutation process, which changes the order of numbers, the substitution process, which substitutes data itself by means of a substitution table, and the processing method which is a combination of these two (2) processes thereby increasing encryption strength.

The encryption/decryption enabling/disabling switching unit 23 changes the setting to enable or disable the functions of the encrypting/decrypting unit 22, and if enabled, the image data once stored in the memory is encrypted or decrypted. On the other hand, if the encrypting/decrypting unit 22 is disabled by the encryption/decryption enabling/disabling switching unit 23, image data stored in the memory is not encrypted or decrypted, and is directly stored in the hard disk 40 as part of the memory.

The deleting unit 24 generates deleting data used to overwrite image data or an image file which is already stored in the hard disk 40 in order to prevent the data from being leaked when the data in the hard disk 40 is deleted. Although the deleting unit 24 according to the present embodiment specifically generates the Null characters (0x00 according to the ASCII cord), other constant numbers may be used as deleting data. The deleting data generated by the deleting unit 24 is previously stored in the memory, and then is overwritten in the hard disk 40.

The data recording unit 25 outputs image data or deleting data previously stored in the memory along with a write request, and drives the hard disk 40 to write the image data or the deleting data. Moreover, the data recording unit 25 outputs a read request to the hard disk 40 to read out an image file recorded in the hard disk 40, and to store the read image file in the memory, thereby preparing the control unit 21 for various forms of processing.

The interface 30 carries out conversion and input/output of data between the image processing unit 20 and the image forming unit 10, and between the image processing unit 20 and the terminal device 2 connected to the image forming device 1 in order to transmit/receive the data.

The hard disk 40 includes an image data recording unit 41 which resides in an area for storing image files, and to which a write request and image data output from the data recording unit 25 are written as a file, and deleting data is overwritten. It should be noted that although the hard disk is used as the data recording medium, in addition thereto, a magnetic disk, an optical disk such as a DVD, or a semiconductor memory may be similarly employed as the data recording medium.

The display/operation panel 50 provided for the image forming device 1 is used to carry out inputting to/operation for the image forming device 1, and includes a display unit which displays various selection screens, functions, and help instructions for operating the device, and an input unit which is used to input various instructions to the control unit 21.

The flow of data processing in the image forming device 1 with reference to FIG. 2 will now be described. First, in step S-100, a process request is generated from the terminal device 2 connected to the image forming device 1 when a user operates the display/operation panel 50. This step is actually executed when a process request is transmitted from the terminal device 2 to the control unit 21 via the interface 30. In the succeeding step S-101, the image forming device determines whether the process request relates to the storage of image data or not. If the process request coming from the display/operation panel 50 or the terminal device 2 is to store image data, image data received from the terminal device 2 is immediately stored in the memory, which is not shown. Moreover, the encryption/decryption enabling/disabling switching unit 23 enables the encrypting/decrypting unit 22 so that the image data is then encrypted in step S-102 using the encryption key, and is stored in the memory in step S-103. The data recording unit 25 is then caused to write and store the encrypted image data stored in the memory as an image file in the image data recording unit 41 of the hard disk 40 in step S-104.

If the process request coming from the terminal device 2 or the display/operation panel 50 is not to store image data in step S-101, the data processing proceeds to step S-110, in which it is determined whether the process request is to delete image data or not. If the process request is a request to delete image data, the data processing proceeds to the next step S-111 in which the encryption/decryption enabling/disabling switching unit 23 disables the encrypting/decrypting unit 22, thereby preventing the data from being encrypted. The deleting unit 24 then generates the Null characters used to overwrite and delete the image file data, and immediately stores the Null characters in the memory. The data recording unit 25 outputs the Null characters stored in the memory to the hard disk 40, and overwrites the file to be deleted in the image data recording unit 41 of the hard disk 40 with the Null characters, thereby deleting the file in step S-112.

In step S-110, if it is determined that the process request from the terminal device 2 or the display/operation panel 50 is not to delete image data, the data processing proceeds to step S-120, in which it is determined whether the process request consists of a request to read image data or not. If the process request is to read image data, the encryption/decryption enabling/disabling switching unit 23 enables the encrypting/decrypting unit 22 in step S-121 so that data is to be decrypted. Then, in step S-122, the data recording unit 25 reads a file from the image data recording unit 41 of the hard disk 40, and stores the read image data in the memory. It is assumed that the read image data has been encrypted in step S-103, and stored in the hard disk 40 in step S-104. The image data stored in the memory is decrypted by the encrypting/decrypting unit 22 in step S-123. The decrypted image data is then transmitted to the image forming unit 10 via the interface 30, and is printed on a sheet, or transmitted to the terminal device 2 for further image processing in step S-124.

According to the first embodiment of the invention, when image data is stored in the hard disk 40, the image data is encrypted, and when such image data is deleted, the stored image file is overwritten with Null characters, which are not encrypted. As a result, since the image data is encrypted it cannot be deciphered, and a portion thereof which has been overwritten and deleted remains as Null characters, thereby blocking an attempt to decipher the encryption algorithm.

Although the description given in the first embodiment of the invention pertains to the case where the image forming device is used as the information processing device, it is apparent that any device such as a computer and an image recording device which include a recording medium such as a hard disk can realize the same functions as described above.

### Second Embodiment

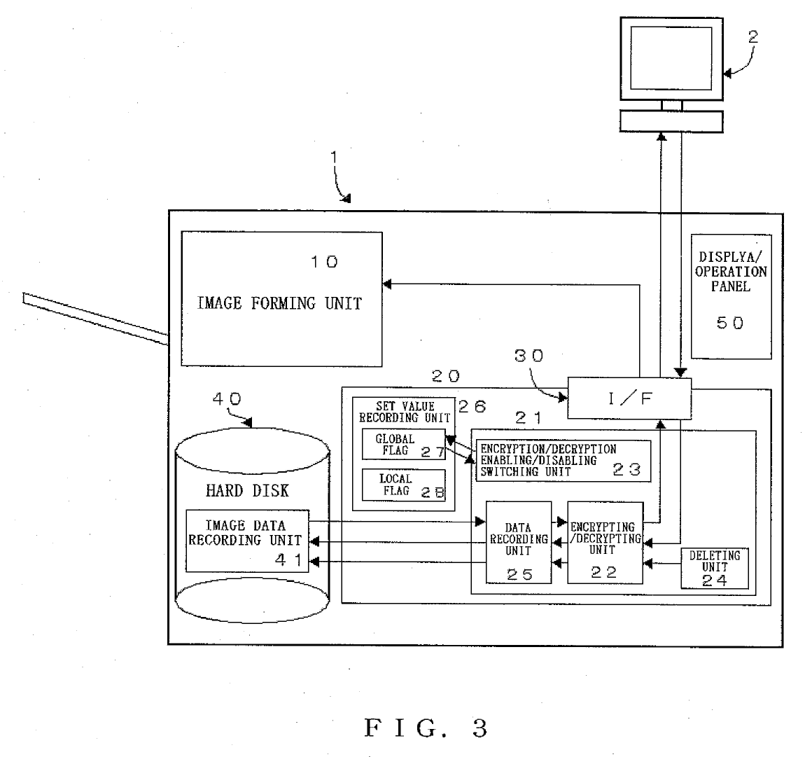

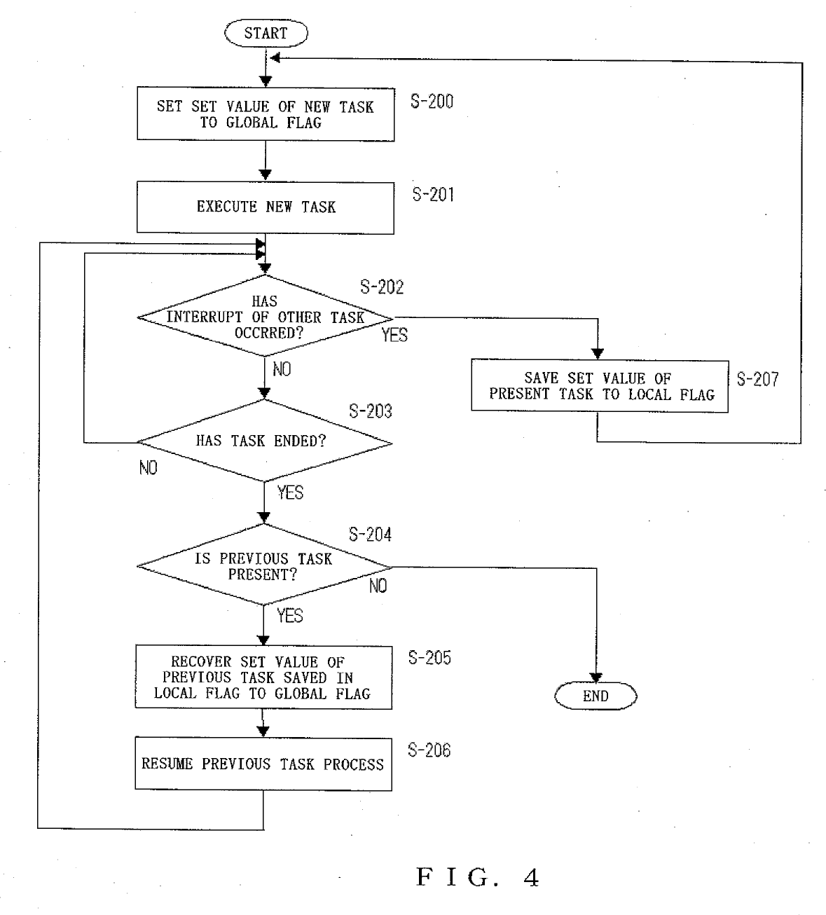

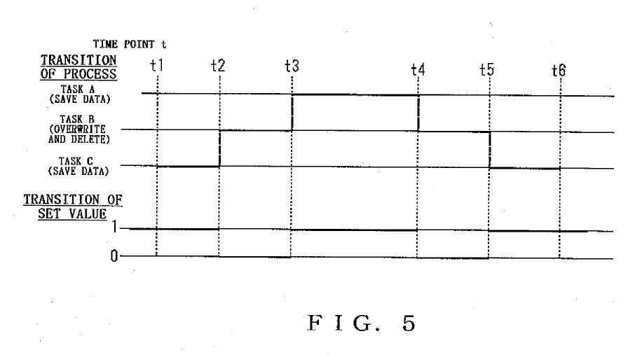

With reference to FIGS. 3 to 5, the image forming device according to the second embodiment of the present invention and data processing thereof will be described hereafter. FIG. 3 presents an overview and a function block diagram of an information processing device according to the second embodiment which shifts between enabling and disabling of an encrypting/decrypting unit, while FIG. 4 is a flowchart showing the operational flow of recording/deleting processes of data conducted by the information processing device according to the second embodiment. FIG. 5 is a time chart showing the switching of operations when an interruption occurs. Similar components are denoted by the same numerals referred to in the first embodiment in FIGS. 3 to 5, and will not be explained further.

With reference to FIG. 3, the information processing device is the image forming device 1 of the first embodiment which includes the image forming unit 10, the image processing unit 20, the interface unit 30, the hard disk 40, and the display/operation panel 50. Likewise, the image forming device 1 is connected to a terminal device 2 such as a computer via a network connection or such other connection method for transmitting/receiving image data as that of the first embodiment.

The image processing unit 20 including the control unit 21 is similar to the image processing unit 20 according to the first embodiment of the invention, which further includes a set value storing unit 26 according to the second embodiment. The control unit 21 includes the encrypting/decrypting unit 22, the encryption/decryption enabling/disabling switching unit 23, the deleting unit 24, and the data recording unit 25.

The set value storing unit 26 serves to store the set value used to determine whether the encryption/decryption enabling/disabling switching unit 23 of the control unit 21 enables or disables the operation of the encrypting/decrypting unit 22, and includes a global flag 27 and a local flag 28. The global flag 27 temporarily stores the set value of the encryption/decryption enabling/disabling switching unit 23 corresponding to a certain task (a unit which refers to one of respective processes executed by the image forming device, such as data storage and data deletion) presently being processed. Moreover, the local flag 28 is used to temporarily save the set value of the encryption/decryption enabling/disabling switching unit 23 corresponding to a previous task when there is an interruption requiring the processing of another task. The global flag 27 and the local flag 28 are actually realized by using a part of the memory provided in the image processing unit 20. Alternatively, the set value recording unit 26 may be integrated with the control unit 21, and may be realized as a part of the register included in the CPU constituting the control unit 21.

The set value used by the encryption/decryption enabling/disabling switching unit 23 to determine whether the operation of the encrypting/decrypting unit 22 is enabled or disabled is assigned to respective tasks, and once the image data received from the terminal device 2 or image data is read out from the hard disk 40 and stored in the memory, the set value received together with the image data or a process request entered from the terminal device 2 or the display/operation panel 50 is stored in the set value recording unit 26. Then, the encryption/decryption enabling/disabling switching unit 23 enables or disables the encrypting/decrypting unit 22 according to the set value stored in the set value storing unit 26 to process the image data.

The image processing executed by the image forming device 1 according to the second embodiment with reference to FIG. 4 will be described next. First, in step S-200, if there is a process request from the terminal device 2 connected to the image forming device 1 or from the display/operation panel 50, the set value assigned to the process request, respective processes, or image data are stored in the global flag 27. The task is then executed according to the process request in step S-201. Tasks include respective processes which encrypt and record image data, decrypt and output encrypted image data, and delete image data. In step S-202, the control unit 21 monitors the incidence of interruptions requiring processing as requested from the terminal device 2 or the display/operation panel 50 during execution of a task. And if the task is simply completed without any interruption in step S-203, the image forming device determines, in step S-204, whether the task has been previously executed. The process ends if the task has not been previously executed.

In step S-204, if it is determined that the task has been previously executed, the set value of the immediately previous task stored in the local flag 28 is read out, and is stored in the global flag 27 in step S-205, and the previous task process resumes in step S-206. After task processing resumes, the image processing returns to step S-202, and the device once again monitors the occurrence of any interruption requiring other processing.

If there is an interruption requiring processing of another task from the terminal device 2 or the display/operation panel 50 in step S-202 during processing of the current task, the set value of the task presently being processed, which is set in the global flag 27, is saved to the local flag 28 in step S-207. The image processing then proceeds again to step S-200, in which the set value of the task for which the interruption requiring another process has occurred, namely the set value of the new task, is stored in the global flag 27, and the new task is executed in accordance with step S-201.

It should be noted that respective tasks may be prioritized, such that if there is a request for processing a task with a higher priority while a certain task is being executed, it is believed that an interruption will occur by way of step S-202, in which case the task presently being executed is temporarily suspended, and the task deemed to be of higher priority is preferentially executed. If the request for processing pertains to a task of equal or lower priority compared to that of the task under execution, the task of equal or lower priority is executed upon completion of the present task.

Next, description will be made of a situation involving the processing of three tasks (i.e., tasks A, B and C are to be executed) by means of the image processing device 1 and the image processing method thereof according to the second embodiment of the invention with reference to the flowchart of FIG. 4 described above, and the time chart of FIG. 5.

FIG. 5 illustrates how the set value stored in the global flag 27 of the set value storing unit 26 changes while the respective tasks A, B, and C are executed, and how the processes shift. In FIG. 5, task A refers to the process of storing data, while task B pertains to the process of overwriting and deletion of data, and task C refers to the process of storing other data, and the priorities of the respective tasks are arranged in ascending order of tasks C, B, and A. Moreover, FIG. 5 illustrates the situation where there is an interruption to process task B while task C is being executed, and there occurs another interruption to process task A while task B is being executed.

First, processing of task C starts at a time point t1, which corresponds to the step S-200 of the flowchart in FIG. 4, and the set value of task C is first set in the global flag 27. Task C involves the storing of ordinary data, and a set value “1” is thus set to the global flag 27. Task C is then executed at a time point t2. The encryption/decryption enabling/disabling switching unit 23 enables the encrypting/decrypting unit 22 based on the set value of the global flag 27, and image data received from the terminal device 2 is encrypted and recorded in the image data recording unit 41 of the hard disk 40.

An interruption requiring the execution of task B occurs at the time point t2 while task C is under execution, which corresponds to steps S-202 and S-207 in FIG. 4, and the set value “1” of task C set in the global flag 27 is saved to the local flag 28. Since task B involves the process of overwriting and deletion of data, a set value “0” for task B is set in the global flag 27 (step S-200), and task B starts in step S-201. The encryption/decryption enabling/disabling switching unit 23 disables the encrypting/decrypting unit 22 based on the set value “0” of the global flag 27, and data to be deleted in the image data recording unit 41 of the hard disk 40 is overwritten with deleting data comprising Null characters or the like generated by the deleting unit 24 to delete the data without being encrypted.

An interruption requiring processing of task A further occurs at a time point t3 in FIG. 5 while task B is under execution. This state corresponds to steps S-202 and S-207 in FIG. 4, and the set value “0” of task B set in the global flag 27 is saved to the local flag 28. Since task A involves the storing of data, the set value “1” of task A is reset to the global flag 27 in step S-200), and task A starts in step S-201. The encryption/decryption enabling/disabling switching unit 23 enables the encrypting/decrypting unit 22 based on the set value “1” of the global flag 27, such that image data received from the terminal device 2 is encrypted and recorded in the image data recording unit 41 of the hard disk 40.

In FIG. 5, time point t4 shows the processes to be executed when task A ends. This state corresponds to the steps S-203 to S-206 in FIG. 4, when processing of task A ends, and the image processing device determines whether there is a task which is being executed. Since task B has been previously executed, in this case, the set value “0” of task B saved in the local flag 28 is reset to the global flag 27, and processing of task B resumes. The encryption/decryption enabling/disabling switching unit 23 disables the encrypting/decrypting unit 22 according to the set value “0” of task B set in the global flag 27, and the hard disk 40 is overwritten with deleting data.

The processing then proceeds to a time point t5 in FIG. 5. Time point t5 shows the processes to be executed when task B ends. The steps S-203 to determines first whether other tasks are being executed before the start of processing for task B, and since task C has been executed, the set value “1” of the task C saved in the local flag 28 is set again to the global flag 27, and the process for task C is resumed. The encryption/decryption enabling/disabling switching unit 23 then enables the encrypting/decrypting unit 22 according to the set value “1” of task C set to the global flag 27, and remaining image data is recorded in the hard disk 40. When task C ends at a time pint t6 in FIG. 5, step S-204, the corresponding process illustrated in FIG. 4 is executed. Namely, the image processing device determines whether another task was under execution before the start of processing for task C, and since there had been no other task before task C as shown in FIG. 5, the entire process ends.

In this manner, according to the second embodiment of the invention, by using a set value which comprises data indicating the operation of the encrypting/decrypting unit 22 for corresponding tasks, prioritizing of tasks in order to execute the process required when an interruption occurs is made possible, thereby causing the encrypting/decrypting unit 22 to operate or not to operate according to the task involved. Moreover, even if processing of another task resulting from an interruption is suspended for some reason, the previous (or interrupted) process can be resumed by restoring its set value.

What is claimed is:

1. An information processing device that encrypts file data and stores the encrypted file data in a data recording medium comprising:
an encrypting means for encrypting the file data;
a data recording means for recording the encrypted file data in the data recording medium;
a deleting means for generating deleting data in order to erase the file data recorded by the data recording means; and
an encryption enabling/disabling switching means,
wherein the encryption enabling/disabling switching means enables the encryption of file data by the encrypting means when ordinary data is recorded in the data recording medium, and disables the encryption carried out by the encrypting means for the deleting data generated by the deleting means when file data recorded in the data recording medium is deleted by overwriting it with deleting data.

2. The information processing device according to claim 1, wherein during the process of recording or deleting first file data, the recording or deletion of first file data is suspended if there is an interruption requiring processing to record or delete second file data, and such process of recording or deleting second file data is carried out.

3. The information processing device according to claim 1, comprising set value storing means, wherein:
the set value storing means stores the state of the encryption enabling/disabling switching means as a set value, and
the encryption enabling/disabling switching means enables or disables the data encryption through the encrypting means based on the set value stored in the set value storing means.

4. The information processing device according to claim 3, wherein:
during the process of recording or deleting first file data, the encryption enabling/disabling switching means enables or disables the encryption of first file data using the encrypting means based on the first set value stored in the set value storing means to execute the process of recording or deletion, and if there is an interruption requiring processing to record or delete second file data, the process of recording or deleting the first file data is suspended, and the encryption enabling/disabling switching means enables or disables the encryption of the second file data using the encrypting means based on the second set value stored in the set value storing means to execute the process of recording or deletion, and
upon completion of the process of recording or deleting the second file data, the encryption enabling/disabling switching means again enables or disables the encryption of the first file data using the encrypting means based on the first set value to resume the process of recording or deleting the first file data.

5. The information processing device according to claim 1, wherein the deleting data generated by the deleting means in order to erase file data recorded by the data recording means comprises constant number data.

6. A computer-readable recording medium that records a program for initiating a computer connected to or provided with the data recording medium to realize:
an encrypting function that encrypts file data;
a data recording function that records encrypted file data in the data recording medium;
a deleting function that generates deleting data in order to erase file data recorded by the data recording function; and
an encryption enabling/disabling switching function that enables the encryption of file data if ordinary data is recorded in the data recording medium, and disables the encryption of the deleting data if file data recorded in the data recording medium is deleted by overwriting the file data with deleting data.

7. The computer-readable recording medium recording the program according to claim 6, wherein, during the process of recording or deleting file data in the data recording medium, the recording or deletion of first file data is suspended if there is an interruption requiring processing to record or delete second file data, and the process of recording or deleting such second file data is carried out.

8. The computer-readable recording medium recording the program according to claim 6, wherein:
the state of the encryption enabling/disabling switching function is stored as a set value, and
the encryption of file data is enabled or disabled based on the set value.

9. The computer-readable recording medium recording the program according to claim 8, wherein:
during the process of recording or deleting file data in the data recording medium, particularly the recording or deletion of first file data, the encryption of the first file data is enabled or disabled based on the stored first set value to execute the recording or deleting process, and if there is an interruption requiring processing to record or delete second file data, the recording or deletion of the first file data is suspended, and the encryption of the second file data is enabled or disabled based on a stored second set value to execute the recording or deleting process, and
upon completion of the process of recording or deleting the second file data, the encryption of the first file data is again enabled or disabled based on the first set value to resume the process of recording or deleting the first file data.

10. The computer-readable recording medium recording the program according to claim 6, wherein the deleting function generates constant number data as deleting data.

11. A data processing method for a computer connected to or provided with a data recording medium, comprising the following steps:
an encrypting step for encrypting file data;
a data recording step for recording the encrypted file data in the data recording medium;
a deleting step for generating deleting data in order to erase the file data recorded by the data recording step; and
an encryption enabling/disabling switching step for enabling encryption of file data if ordinary data is recorded in the data recording medium, and disabling encryption of the deleting data if file data recorded in the data recording medium is erased by overwriting the file data with deleting data.

12. The data processing method according to claim 11, comprising the step of suspending the process of recording or deleting first file data during the recording or deletion thereof, if there is an interruption requiring the recording or deletion of second file data, and executing the process of recording or deleting such second file data.

13. The data processing method according to claim 11, comprising:
the step of storing the state of the encryption enabling/disabling switching as a set value; and
the step of enabling or disabling the encryption of file data based on the set value.

14. The data processing method according to claim 13, during the process of recording or deleting first file data, comprising the step of enabling or disabling the encryption of the first file data based on the stored first set value to execute the process of recording or deletion, and if there is an interruption requiring the recording or deletion of second file data, suspending the process of recording or deleting the first file data and enabling or disabling the encryption of second file data based on the stored second set value to execute the process of recording or deletion, and upon completion of the process of recording or deleting the second file data, enabling or disabling the encryption of the first file data based on the first set value to resume the process of recording or deleting the first file data.

15. The data processing method according to claim 11, wherein the deleting data generated by the step of generating deleting data comprises constant number data.
